(19) United States
(12) Patent Application Publication
(10) Pub. No.: US 2006/0141223 A1
(43) Pub. Date: Jun. 29, 2006

(54) Enhancing the watertightness of textile sheetlike constructions, textile sheetlike constructions thus finished and use thereof

(75) Inventors: Markus Oles, Hattingen (DE); Edwin Nun, Billerbeck (DE); Volker Hennige, Duelmen (DE); Peter Mayr, Trippstadt (DE); Peter Rudek, Worms (DE); Gerhard Schoepping, Hemsbach (DE); Uwe Marg, Aubure (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 11/321,285

(22) Filed: Dec. 27, 2005

(30) Foreign Application Priority Data
Dec. 27, 2004 (DE) 10 2004 062 743.6

(51) Int. Cl. B32B 27/04; B32B 27/12; B05D 1/12; E01F 9/04; B32B 3/00; B05D 7/00

(52) U.S. Cl. 428/172; 427/180; 427/402; 442/189; 442/79; 442/86; 428/156; 428/143

(57) ABSTRACT

The present invention relates to textile sheetlike constructions having an enhanced watertightness and also to a process for producing them. It was found that, surprisingly, the watertightness of porous textile sheetlike constructions is enhanced when a coating of hydrophobic particles having an average particle size in the range from 0.02 to 100 μm is applied to the surfaces of the fibers. The textile sheetlike constructions can be used for example as textile building materials or for producing tents, umbrellas or the like.

### BACKGROUND OF THE INVENTION

1. Field of the Invention

The present invention relates to a process for enhancing the watertightness of materials, to materials produced by this process and to the use thereof.

2. Description of the Background

Hydrophobic permeable materials are well known. In particular, membranes composed of Teflon, but also of other organic polymers may be mentioned here. They are useful for a wide variety of applications where it is crucial that the porous material of construction be permeable only to gas or vapor and not to liquid. One way of producing these materials is by stretching (expanding) Teflon films to produce very small cracks which then allow the passage of vapor or gas. The hydrophobic material is impervious to water droplets, since the high surface tension and the nonwettability of the surfaces of the hydrophobic materials prevent water droplets from penetrating the pores.

Such hydrophobic materials are useful for membrane filtration as well as gas and vapor permeation. In addition, they are used as inert filtering materials in many sectors. One disadvantage with these materials is in particular that they are relatively complicated to manufacture, which leads to relatively high prices and hence prevents universal application of these materials.

Relatively inexpensive systems comprise wovens or nonwovens as base materials. These are typically impregnated by coating them with fluorocarbons, in particular with Teflon. This coating is usually referred to as a fluorocarbon finish (a term from the dry cleaning arts). Fluorocarbon finishes hydrophobicize these textile sheetlike constructions. Hydrophobicization is a way of providing enhanced watertightness. The technique most resembles the sol-gel technique, since a monomolecular coating is created. Water vapor permeability remains substantially unaffected by fluorocarbons. However, the fluorocarbon finishing of wovens or nonwovens is likewise inconvenient and hence costly.

A less costly and simpler process for enhancing the watertightness of materials is to coat materials with polyurethane. However, in polyurethane coating, the wovens or nonwovens have applied to them coatings which resemble self-supporting films and which do indeed possess outstanding watertightness, but also a water vapor perviousness of almost nil, since the porosity of the woven or nonwoven is lost.

The so-called lotus effect is the well-known principle of self-cleaning. To achieve good self-cleaning (superhydrophobicity) on a surface, the surface has to have some degree of roughness as well as being very hydrophobic. A suitable combination of structure (texture) and hydrophobicity will ensure that even small amounts of moving water will entrain soil particles adhering to the surface and clean the surface (WO 96/04123).

EP 0 933 388 discloses that such self-cleaning surfaces require an aspect ratio of >1 and a surface energy of less than 20 mN/m. Aspect ratio is here defined as the ratio of the height of the structure to its width. The aforementioned criteria are actualized in nature, for example in the lotus leaf. The surface of the plant, formed from a hydrophobic waxy material, has elevations which are spaced apart by a few μm. Water droplets will essentially contact only the tips of the elevations. Such water-rejecting surfaces are extensively described in the literature.

EP 0 909 747 teaches a process for producing a self-cleaning surface. The surface has hydrophobic elevations 5 to 200 μm high. A surface of this type is produced by application of a dispersion of powder particles and an inert material in a siloxane solution and subsequent curing. The structure-forming particles are thus immobilized on the substrate by an auxiliary medium.

WO 00/58410 concludes that it is technically possible to make surfaces of articles artificially self-cleaning. The surface structures necessary for this, composed of elevations and depressions, have a distance in the range from 0.1 to 200 μm between the elevations of the surface structures and an elevation height in the range from 0.1 to 100 μm. The materials used for this purpose have to consist of hydrophobic polymers or durably hydrophobicized material.

DE 101 18 348 describes polymeric fibers having self-cleaning surfaces wherein the self-cleaning surface is obtained by the action of a solvent comprising structure-forming particles, incipiently dissolving the surface of the polymeric fibers by the solvent, adhering the structure-forming particles to the incipiently dissolved surface and removing the solvent. The disadvantage with this process is that processing of the polymeric fibers by spinning, knitting, etc. may cause the structure-forming particles and hence the structure responsible for the self-cleaning surface to become damaged or even completely lost in certain circumstances and hence cause the self-cleaning effect to be lost as well.

DE 101 18 346 describes textile sheetlike constructions having a self-cleaning and water-repellent surface, constructed from at least one synthetic and/or natural textile base material A and an artificial, at least partly hydrophobic surface having elevations and depressions comprising particles securely bonded to the base material A without adhesives, resins or lacquers, that are obtained by treating the base material A with at least a solvent containing the particles in undissolved form and removing the solvent to leave at least a portion of the particles securely bonded to the surface of the base material A.

However, none of these references reveals that textile sheetlike constructions possessing enhanced watertightness can be produced by applying hydrophobic particles or nonhydrophobic particles which are hydrophobicized after they have been applied.

### SUMMARY OF THE INVENTION

The present invention therefore has for its object to provide a simpler process for rendering porous textile sheetlike constructions, i.e., in particular nonwovens, wovens, formed-loop knits or felts, watertight to a very substantial degree while at the same time leaving the water vapor permeability of the fiber material virtually unchanged compared with the untreated fiber material.

We have found that this object of enhancing the watertightness of textile sheetlike constructions is achieved, surprisingly, when the textile sheetlike constructions, or to be more precise the fibers of the textile sheetlike constructions, are coated with hydrophobic particles as already practiced to achieve the lotus effect for example.

The present invention is thus based on the so-called lotus effect, i.e., the well-known principle of self-cleaning. To achieve good self-cleaning (superhydrophobicity) on a surface, the surface has to have some degree of roughness as well as being very hydrophobic. A suitable combination of structure (texture) and hydrophobicity will ensure that even small amounts of moving water will entrain soil particles adhering to the surface and clean the surface.

The present invention accordingly provides a process for enhancing the watertightness of a porous textile sheetlike construction, characterized in that the textile sheetlike construction has applied to it hydrophobic particles or nonhydrophobic particles, which are hydrophobicized in a subsequent operation, having an average particle size in the range from 0.02 to 100 μm by applying a suspension which comprises the particles in a solvent and subsequently removing the solvent which become fixed to the fibers of the textile sheetlike construction and thus endow the surfaces of the fibers with a structure composed of elevations and/or depressions, the elevations having a spacing in the range from 20 nm to 100 μm and a height in the range from 20 nm to 100 μm.

The present invention likewise provides textile sheetlike constructions having enhanced watertightness which are characterized in that they comprise fibers having a hydrophobic surficial structure composed of elevations having an average height in the range from 50 nm to 25 μm and an average spacing in the range from 50 nm to 25 μm.

The sheetlike constructions of the present invention have a wide variety of uses. As membranes, when compared with conventional purely organic membranes, they have the advantage, by virtue of their self-cleaning properties, of possessing distinctly longer operating lives than membranes without self-cleaning surfaces. Since the hydrophobicization of the surfaces of the membranes is due to the hydrophobic particles, the pores, in particular the number of pores and also their size, is substantially unaffected by the hydrophobicization, so that a sheetlike construction according to the present invention has virtually the same flux and retention properties as the corresponding untreated sheetlike construction (of course with the exception of the perviousness to water).

Not only textile sheetlike constructions but also membranes are notable for a high porosity. The pores or holes can be viewed as channels whose width is determined by the pore size and whose length is determined by their path through the membrane or sheetlike construction. Typically, the length of these channels is longer than the thickness of the textiles. Water has to diffuse through these channels.

The sheetlike constructions of the present invention also have appreciable advantages as technical or industrial textiles. Water vapor permeability is not reduced even though permeability to liquid water is appreciably reduced. This effect is also utilized in vapor permeation, which is why the sheetline constructions of the present invention are particularly effective for use as a membrane in these processes. The process for producing the sheetlike constructions has the advantage that it can be carried out in a very simple manner, for example by spraying with a particulate suspension.

### BRIEF DESCRIPTION OF THE FIGURES

The process of the present invention and the textile sheetlike construction of the present invention are more particularly described with reference to the FIG. 1 figure without being limited thereto.

FIG. 1 is a schematic illustration of the difference between elevations formed by particles and elevations formed by the fine structure. The figure shows in simplified form the surface of a sheetlike construction X which comprises particles P (only one particle is depicted for simplicity). The elevation which is formed by the particle itself has an aspect ratio of about 0.71, reckoned as ratio of the maximum height of the particle mH, which is 5, since only that portion of the particle which protrudes from the surface of the sheetlike construction or from the fibers of the sheetlike construction X makes a constribution to the elevation, to the maximum width mB, which is 7 in relation thereto. A selected elevation of the elevations E, which are present on the particles by virtue of the fine structure of the particles, has an aspect ratio of 2.5, reckoned as ratio of the maximum height of the elevation mH′, which is 2.5, to the maximum width mB′, which is 1 in relation thereto.

### DETAILED DESCRIPTION OF THE INVENTION

The process of the present invention and also textile sheetlike constructions produced by this process will now be described without the invention being restricted to these embodiments.

In the present invention's process for enhancing the watertightness of porous textile sheetlike constructions, the textile sheetlike construction has applied to it particles, in particular hydrophobic particles or nonhydrophobic particles, which are hydrophobicized in a subsequent operation, having an average particle size in the range from 0.02 to 100 μm by applying a suspension which comprises the particles undissolved in a solvent and subsequently removing the solvent which become fixed to the fibers or the substrate of the textile sheetlike construction and thus endow the surfaces of the fibers or the substrate with a structure composed of elevations and/or depressions, the elevations having a spacing in the range from 20 nm to 100 μm and a height in the range from 20 nm to 100 μm. The range for the average particle size includes all specific values and subranges therebetween, such as 0.05, 0.10, 0.25, 0.5, 1, 2, 5, 10, 25, 30, 50, 75, 90 and 95 μm. The ranges for the spacing and height of the elevationss include all specific values and subranges therebetween, such as 25, 50 or 100 nm or 25, 30, 40, 50, 60, 70, 80 and 90 μm.

Formed-loop knits, wovens, nonwovens or felts or membranes can be used as textile sheetlike constructions. The average mesh or pore size of such sheetlike constructions is preferably in the range from 0.5 to 200 μm, preferably in the range from 0.5 μm to 50 μm and more preferably in the range from 0.5 μm to 10 μm.

The applying of the suspension to at least one surface of the textile sheetlike construction may be effected in various ways known to one skilled in the art, for example by spraying, knifecoating, dipping or rolling. Preferably, the particles are applied by dipping the sheetlike construction into the suspension or by spraying the suspension onto the sheetlike construction. More preferably, the applying and fixing of the particles is effected such that the particles are present not just at the surface of the textile sheetlike construction but also in the pores or meshes of the textile sheetlike construction. The presence of the hydrophobic or hydrophobicized particles in the pores or meshes provides for particularly good watertightness.

The fixing of the particles after the suspension has been applied may be effected in various ways. In the simplest embodiment, the surface of the fibers of the textile sheetlike construction is not incipiently dissolved by the solvent and after the solvent has been removed the particles adhere to the surface of the fibers or substrate. Examples of suitable solvents which do not incipiently dissolve the surface of the article to be coated are compounds selected from the group of the alcohols, the glycols, the ethers, the glycol ethers, the ketones, the esters, the amides, the nitro compounds, the (hydro)halocarbons, the aliphatic and aromatic hydrocarbons or a mixture thereof. For each fiber or substrate material it is necessary to select a suitable solvent which does not dissolve the fiber material.

In another embodiment of the process according to the present invention, the surface of the fibers is incipiently dissolved by the solvent. After the solvent has been removed, the particles are anchored in the surface of the fibers. The surface which is incipiently dissolved by a solvent preferably comprises polymers based on polycarbonates, poly(meth)acrylates, polyamides, PVC, polyethylenes, polypropylenes, aliphatic linear or branched alkenes, cyclic alkenes, polystyrenes, polyesters, polyether sulfones, polyacrylonitrile or polyalkylene terephthalates and also their blends or copolymers.

Preferably, at least one compound suitable for use as solvent for the corresponding surface is selected from the group of the alcohols, the glycols, the ethers, the glycol ethers, the ketones, the esters, the amides, the nitro compounds, the (hydro)halocarbons, the aliphatic and aromatic hydrocarbons or mixtures thereof and is used as solvent. More preferably, at least one compound suitable for use as solvent for the corresponding surface is selected from methanol, ethanol, propanol, butanol, octanol, cyclohexanol, phenol, cresol, ethylene glycol, diethylene glycol, diethyl ether, dibutyl ether, anisole, dioxane, dioxolane, tetrahydrofuran, monoethylene glycol ether, diethylene glycol ether, triethylene glycol ether, polyethylene glycol ether, acetone, butanone, cyclohexanone, ethyl acetate, butyl acetate, isoamyl acetate, ethylhexyl acetate, glycol ester, dimethylformamide, pyridine, N-methylpyrrolidone, N-methylcaprolactone, acetonitrile, carbon sulfide, dimethyl sulfoxide, sulfolane, nitrobenzene, dichloromethane, chloroform, tetrachloromethane, trichloroethene, tetrachloroethene, 1,2-dichloroethane, chlorophenol, chlorofluorocarbons, benzines, petroleum ether, cyclohexane, methylcyclohexane, decalin, tetralin, terpenes, benzene, toluene or xylene or mixtures thereof and used as solvent.

In this embodiment of the process according to the present invention, it is advantageous when the dispersion or solvent which comprises the particles has a temperature in the range from −30° C. to 300° C. and preferably in the range from 25 to 100° C. before being applied to the surface.

The particles used are preferably selected from silicates, minerals, metal oxides, metal powders, silicas, pigments or polymers, most preferably from pyrogenic silicas, precipitated silicas, alumina, mixed oxides, doped silicates, titanium dioxides or pulverulent polymers.

The particles used preferably have an average particle size in the range from 0.05 to 30 μm and more preferably in the range from 0.1 to 10 μm. But suitable particles may also have a diameter of less than 500 nm, or be combined from primary fragments to form agglomerates or aggregates having a size in the range from 0.2 to 100 μm.

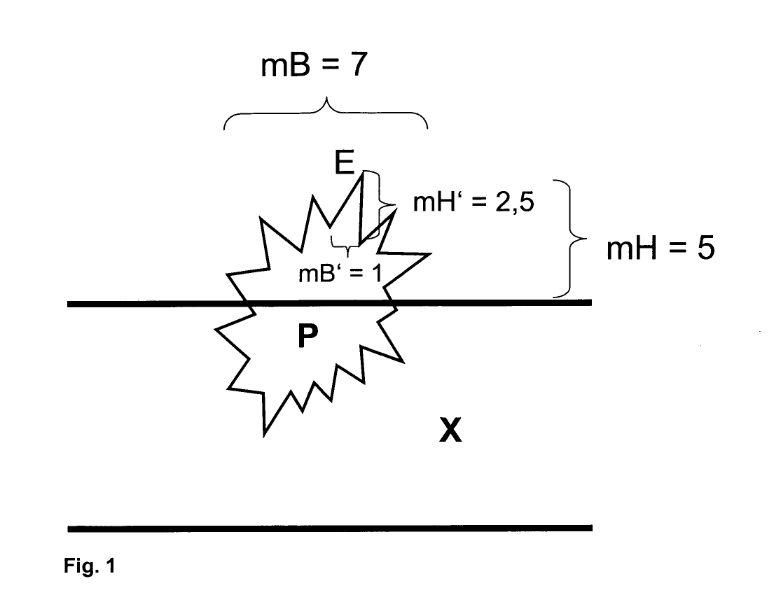

Particularly preferred particles to form the elevations are those which have an irregular fine structure in the nanometer region on the surface. The particles which have an irregular fine structure preferably comprise elevations or fine structures having an aspect ratio of greater than 1 and more preferably greater than 1.5. Aspect ratio here is again defined as the ratio of an elevation's maximum height to its maximum width. FIG. 1 provides a schematic illustration of the difference between the elevations formed by the particles and the elevations formed by the fine structure. FIG. 1 figure shows the surface of a sheetlike construction X comprising particles P (although only one particle is depicted for simplicity). The elevation which has formed by the particle itself has an aspect ratio of about 0.71, reckoned as ratio of the maximum height of the particle mH, which is 5, since only that portion of the particle which protrudes from the surface of the sheetlike construction X contributes to the elevation, to the maximum width mB, which is 7 in relation thereto. A selected elevation of the elevations E which are present on the particles by virtue of the fine structure of the particles has an aspect ratio of 2.5, reckoned as the ratio of the maximum height of the elevation mH′, which is 2.5, to the maximum width mB′, which is 1 in relation thereto.

Preferred particles, which have an irregular fine structure in the nanometer region on the surface, comprise at least one compound selected from pyrogenic silica, precipitated silicas, alumina, mixed oxides, doped silicates, titanium dioxides or pulverulent polymers.

It may be advantageous when the particles have hydrophobic properties, in which case the hydrophobic properties may be due to the material properties of the materials present on the surfaces of the particles or else are obtainable by a treatment of the particles with a suitable compound. The particles may have been endowed with hydrophobic properties before or after application to the surface of the sheetlike construction.

To hydrophobicize the particles before or after application to the sheetlike construction, they may be treated with a suitable hydrophobicizing compound, for example from the group of the alkylsilanes, the fluoroalkylsilanes or the disilazanes.

Very preferred particles will now be more particularly described. The particles may be from different sectors. For example, they can be silicates, doped silicates, minerals, metal oxides, alumina, silicas or titanium dioxides, aerosils or pulverulent polymers, for example spray-dried and agglomerated emulsions or cryomilled PTFE. Useful particulate systems include in particular hydrophobicized pyrogenic silicas, so-called Aerosils®. Hydrophobicity is needed to generate the self-cleaning surfaces as well as structure. The particles used may themselves be hydrophobic, like pulverulent polytetrafluoroethylene (PTFE) for example. The particles may have been rendered hydrophobic, like Aerosil VPR 411® or Aerosil R 8200® for example. But they may also be subsequently hydrophobicized. In this case it is immaterial whether the particles are hydrobicized before or after application. Such particles to be hydrophobicized are for example Aeroperl 90/30®, Sipernat Kieselsäure 350® silica, Aluminiumoxid C® alumina, zirconium silicate, vanadium-doped or Aeroperl P 25/20®. In the case of the latter, hydrophobicization is advantageously effected by treatment with perfluoroalkylsilane compounds and subsequent heat treatment. Particularly preferred particles are the Aerosils® VPLE 8241, VPR411 and R202 from Degussa AG.

The process of the present invention makes it possible to produce the present invention's textile sheetlike constructions having enhanced watertightness, which are characterized in that the sheetlike constructions comprise fibers which comprise a hydrophobic surficial structure composed of elevations having an average height in the range from 50 nm to 25 μm and an average spacing in the range from 50 nm to 25 μm.

The surface structure which is formed by the particles and which may have self-cleaning properties preferably comprises elevations having an average height in the range from 20 nm to 25 μm and an average spacing in the range from 20 nm to 25 μm, preferably having an average height in the range from 50 nm to 10 μm and/or an average spacing in the range from 50 nm to 10 μm and most preferably having an average height in the range from 50 nm to 4 μm and/or an average spacing in the range from 50 nm to 4 μm. Most preferably, the sheetlike constructions of the present invention comprise fibers having surfaces having surfaces elevations having an average height in the range from 0.25 to 1 μm and an average spacing in the range from 0.25 to 1 μm. Average spacing of elevations refers for the purposes of the present invention to the distance from the highest elevation of an elevation to the next highest elevation. When an elevation has the shape of a cone, then the tip of the cone will constitute the highest elevation of the elevation. When the elevation is a cuboid, then the uppermost surface of the cuboid will constitute the highest elevation of the elevation. The particles are preferably disposed at an average spacing to each other in the range from 0 to 10 particle diameters and preferably in the range from 3 to 5 particle diameters.

The above-described particles may be present as particles. The particles may be fixed to the surface of the fibers of the textile sheetlike constructions directly by physical forces or else in the surface of the fibers themselves or by means of a binder system. The textile sheetlike constructions may be for example fibrous formed-loop knits, nonwovens, wovens or felts or membranes. Fibers in the realm of the present invention shall also comprehend filaments, threads or similar objects which can be processed to form nonwovens, wovens, formed-loop knits or felts.

Very particularly preferred textile sheetlike constructions comprise a polymeric fibrous nonwoven web. The polymeric fibers are preferably selected from polyacrylonitrile, polyamides, polyimides, polyacrylates, polytetrafluoroethylene, polyesters, for example polyethylene terephthalate, and/or polyolefins, for example polypropylene, polyethylene or mixtures thereof. It may be advantageous if the polymeric fibers of the textile sheetlike construction have a diameter in the range from 1 to 25 μm and preferably in the range from 2 to 15 μm. When the polymeric fibers are distinctly thicker than the ranges mentioned, the flexibility of the sheetlike construction will suffer. When the polymeric fibers are distinctly thinner, the breaking strength of the textile sheetlike construction will decrease to such an extent that industrial utilization and further processing is only possible with difficulty, if at all.

When the sheetlike constructions of the present invention have self-cleaning properties, these self-cleaning properties will be attributable to the wetting properties, which can be described by the contact angle which a drop of water makes with a surface. A contact angle of 0 degrees denotes complete wetting of the surface. The static contact angle is generally measured by means of instruments whereby the contact angle is determined optically. Smooth hydrophobic surfaces typically have static contact angles of less than 125°. The present sheetlike constructions having self-cleaning properties have static contact angles of preferably greater than 130°, more preferably greater than 140° and most preferably greater than 145°. It was also found that a surface will have good self-cleaning properties only when its difference between advancing angle and receding angle is not more than 10°, which is why the difference between the advancing angle and the receding angle is preferably less than 10°, preferably less than 5° and most preferably less than 4° for self-cleaning sheetlike constructions in accordance with the present invention. To determine the advancing angle, a drop of water is placed on the surface by means of a canula and the drop on the surface is increased in size by adding water through the canula. As it increases in size, the edge of the drop will glide over the surface and the contact angle is determined as advancing angle. The receding angle is measured on the same drop except that water is withdrawn from the drop through the canula and the contact angle is measured as the drop decreases in size. The difference between the two angles is referred to as hysteresis. The smaller the difference, the lower the interaction of the drop of water with the surface of the substrate and the better the lotus effect (the self-cleaning property).

The surface structures obtained on the fibers have an aspect ratio, formed by the particles, which differs according to the method used to produce the sheetlike constructions of the present invention. When the particles are anchored in the surface of the fibers or using a binder system, then the surface structure preferably has an aspect ratio of greater than 0.15 for the elevations. Preferably, the elevations which are formed by the particles themselves have an aspect ratio in the range from 0.3 to 0.9 and more preferably in the range from 0.5 to 0.8. The aspect ratio in question is defined as the ratio of the maximum height of the structure of the elevations to its maximum width.

To achieve the aspect ratios mentioned, it is advantageous when at least a portion of the particles, preferably more than 50% of the particles, have been embedded into the surface of the fiber or into the binder system up to 90% of their diameter only. The surface accordingly preferably comprises particles which are anchored with 10% to 90%, preferably 20% to 50% and most preferably 30% to 40% of their average particle diameter in the surface or binder system and so still protrude from the surface with parts of their inherently fissured surface. This ensures that the elevations which are formed by the particles themselves have a sufficient aspect ratio of preferably not less than 0.15. This also ensures that the firmly attached particles are very durably attached to the surface of the self-supporting film. The aspect ratio in question is defined as the ratio of the maximum height of the elevations to their maximum width. A particle which has an idealized spherical shape and protrudes to 70% from the surface of the fiber of the sheetlike construction accordingly has an aspect ratio of 0.7 by this definition.

It may be advantageous when the textile sheetlike construction of the present invention comprises a second sheetlike construction or a plurality of treated or untreated sheetlike constructions which are present on one or both of the sides of the sheetlike construction endowed with particles. The additional sheetlike constructions may have been bonded to the first sheetlike construction. This bonding may be effected for example by adhering, in particular at the edges. But the sheetlike constructions may also be stitched or quilted to the first sheetlike construction but also to each other to create a strong bonded system in the form of a textile sheetlike construction. Applying sheetlike constructions with or without attached particles to one or both of the sides of the sheetlike construction endowed with particles ensures that in particular when there are particles not firmly anchored to the surface of the fibers these particles are not removed from the textile sheetlike construction but remain firmly fixed to the surface. Using different sheetlike constructions on one or both of the sides makes it possible to produce sheetlike constructions whose one side possesses particularly high watertightness while the other side possesses a somewhat hydrophilic surface. This makes it possible to obtain textile sheetlike constructions which, in the sports sector in particular, are most suitable for passing moisture in the form of perspiration out through the sheetlike construction while at the same time preventing penetration by rainwater.

The textile sheetlike constructions of the present invention have a watertightness which is distinctly better than the watertightness of textile sheetlike constructions without particles. The maximum mesh or pore size of sheetlike constructions to be treated increases with increasing thickness for the sheetlike construction, since the channels lengthen with increasing thickness. The watertightness of sheetlike constructions according to the present invention is preferably greater than 20 cm and preferably greater than 25 cm hydrohead, as measured to DIN EN 13562.

The textile sheetlike constructions of the present invention are useful for producing umbrellas, awnings, tents, textile building materials and the like. The process can be used for equipping umbrellas, tents, awnings, textile building materials and the like with textile sheetlike constructions in accordance with the present invention. The articles equipped according to the present invention demonstrate particularly good watertightness.

### EXAMPLES

The process of the present invention will now be described by way of example with reference to the following examples without the invention being restricted thereto.

### Example 1

A woven polyester fabric, 20 μm fiber diameter, is dipped for 10 seconds into a hot suspension of 1% by weight of Aerosil VPLE 8241 in decalin at 50° C. The fabric is then dried, no solvent remaining on the surface.

To verify watertightness, the fabric is stretched underneath a glass column 2.5 cm in diameter. The glass column is then gradually filled with water from the top. The filling operation was stopped once the second drop of water had been forced through the treated fabric of the present invention. The water column generated at that time in the glass column was measured. An untreated fabric was tested in the same way. It was determined that the fabric treated according to the present invention was capable of supporting a 25 cm water column before the second drop of water was forced through the fabric. The untreated fabric tested for comparison was found to be capable of supporting just a 4 cm water column before the second drop of water was forced through the fabric. The treatment of the present invention had increased the watertightness of the polyester fabric by more than 600%.

### Example 2

A woven polyester fabric, 15 μm fiber diameter, is dipped for 10 seconds into a hot suspension of 1% by weight of Aerosil VPLE 8241 in toluene at 50° C. The fabric is then dried, no solvent remaining on the surface.

To verify watertightness, the fabric was examined as in Example 1. It was determined that the fabric treated according to the present invention was capable of supporting a 110 cm water column before the second drop of water was forced through the fabric. The untreated fabric tested for comparison was found to be capable of supporting just a 40 cm water column before the second drop of water was forced through the fabric. The treatment of the present invention had increased the watertightness of the polyester fabric by more than 100%.

This application is based on German application No. 102004062740.1, filed Dec. 27, 2004 and incorporated herein by reference.

1. A process for enhancing the watertightness of a porous textile sheetlike construction having fibers, comprising:
applying to the textile sheetlike construction a suspension of hydrophobic particles or nonhydrophobic particles having an average particle size in the range from 0.02 to 100 μm in a solvent, followed by removing the solvent, to fix the particles to the fibers of the textile sheetlike construction and provide the surfaces of the fibers with a structure composed of elevations and/or depressions, wherein the elevations have a spacing in the range from 20 nm to 100 μm and a height in the range from 20 nm to 100 μm, and subsequently hydrophobicizing the nonhydrophobic particles.

2. The process of claim 1, wherein the hydrophobic particles are applied to the textile sheetlike construction.

3. The process of claim 1, wherein the nonhydrophobic particles are applied to the textile sheetlike construction.

4. The process of claim 1, wherein the surfaces of the fibers have a structure composed of the elevations.

5. The process of claim 1, wherein the textile sheetlike construction is at least one member selected from the group consisting of formed-loop knits, wovens, nonwovens, felts and membranes.

6. The process of claim 1, wherein the suspension is applied to at least one surface of the textile sheetlike construction by dipping the sheetlike construction into the suspension.

7. The process of claim 1, wherein the suspension is applied to at least one surface of the textile sheetlike construction by spraying the suspension onto the sheetlike construction.

8. The process of claim 1, wherein the surface of the fibers of the textile sheetlike construction is not incipiently dissolved by the solvent and after the solvent has been removed the particles adhere to the surface of the fibers of the textile sheetlike construction.

9. The process of claim 1, wherein the surface of the fibers of the textile sheetlike construction is not incipiently dissolved by the solvent, and the solvent comprises at least one member selected from the group consisting of the alcohols, the glycols, the ethers, the glycol ethers, the ketones, the esters, the amides, the nitro compounds, the (hydro)halocarbons, and the aliphatic and aromatic hydrocarbons.

10. The process of claim 1, wherein the surface of the fibers is incipiently dissolved by the solvent and after the solvent has been removed the particles are anchored in the surface of the fibers.

11. The process of claim 1, wherein the surface of the fibers is incipiently dissolved by the solvent, and the surface which is incipiently dissolved by a solvent comprises polymers based on polycarbonates, poly(meth)acrylates, polyamides, PVC, polyethylenes, polypropylenes, aliphatic linear or branched alkenes, cyclic alkenes, polystyrenes, polyesters, polyether sulfones, polyacrylonitrile or polyalkylene terephthalates and also their blends or copolymers.

12. The process of claim 1, wherein the surface of the fibers is incipiently dissolved by the solvent and the solvent comprises at least one member selected from the group consisting of the alcohols, the glycols, the ethers, the glycol ethers, the ketones, the esters, the amides, the nitro compounds, the (hydro)halocarbons, and the aliphatic and aromatic hydrocarbons.

13. The process of claim 12, wherein the solvent comprises at least one member selected from the group consisting of methanol, ethanol, propanol, butanol, octanol, cyclohexanol, phenol, cresol, ethylene glycol, diethylene glycol, diethyl ether, dibutyl ether, anisole, dioxane, dioxolane, tetrahydrofuran, monoethylene glycol ether, diethylene glycol ether, triethylene glycol ether, polyethylene glycol ether, acetone, butanone, cyclohexanone, ethyl acetate, butyl acetate, isoamyl acetate, ethylhexyl acetate, glycol ester, dimethylformamide, pyridine, N-methylpyrrolidone, N-methylcaprolactone, acetonitrile, carbon sulfide, dimethyl sulfoxide, sulfolane, nitrobenzene, dichloromethane, chloroform, tetrachloromethane, trichloroethene, tetrachloroethene, 1,2-dichloroethane, chlorophenol, chlorofluorocarbons, benzines, petroleum ether, cyclohexane, methylcyclohexane, decalin, tetralin, terpenes, benzene, toluene and xylene.

14. The process of claim 1, wherein the solvent has a temperature in the range from −30° C. to 300° C. before being applied.

15. The process of claim 1, wherein the solvent has a temperature in the range from 25 to 100° C. before being applied.

16. The process of claim 1, wherein the particles have an average particle size in the range from 0.05 to 30 μm.

17. The process of claim 1, wherein the nonhydrophobic particles are endowed with hydrophobic properties by a treatment with at least one compound selected from the group consisting of alkylsilanes, fluoroalkylsilanes and disilazanes.

18. A textile sheetlike construction having enhanced watertightness, wherein the sheetlike construction comprises fibers which comprise a hydrophobic surface structure composed of elevations having an average height in the range from 50 nm to 25 μm and an average spacing in the range from 50 nm to 25 μm.

19. A sheetlike construction produced by the process of claim 1.

20. The sheetlike construction of claim 19, which has a watertightness of greater than 20 cm hydrohead as measured according to DIN EN 13562.

21. The sheetlike construction of claim 20, which has a watertightness of greater than 25 cm hydrohead.

22. An article selected from the group consisting of umbrellas, tents, awnings, roofing underlayments, hygiene articles, diapers and textile building materials, which contains the sheetlike construction of claim 18.

23. A method of making the article of claim 22, comprising incorporating the sheetlike construction into an umbrella, tent, awning, roofing underlayment, hygiene article, diaper or textile building material.

24. An article selected from the group consisting of umbrellas, tents, awnings, roofing underlayments, hygiene articles, diapers and textile building materials, which contains the sheetlike construction of claim 19.

25. A method of making the article of claim 24, comprising incorporating the sheetlike construction into an umbrella, tent, awning, roofing underlayment, hygiene article, diaper or textile building material.
